(19) United States
(12) Patent Application Publication
(10) Pub. No.: US 2022/0255628 A1
(43) Pub. Date: Aug. 11, 2022

(54) A MODULATOR FOR GENERATING AN ASYMMETRICALLY CLIPPED OPTICAL, ACO, ORTHOGONAL FREQUENCY DIVISION MULTIPLEXING, OFDM, SIGNAL AS WELL AS A CORRESPONDING DEMODULATOR

(71) Applicant: SIGNIFY HOLDING B.V., EINDHOVEN (NL)

(72) Inventor: Johan Paul Marie Gerard LINNARTZ, EINDHOVEN (NL)

(21) Appl. No.: 17/626,034

(22) PCT Filed: Jul. 6, 2020
(86) PCT No.: PCT/EP2020/068947

§ 371 Date: Jan. 10, 2022

(30) Foreign Application Priority Data
Jul. 11, 2019 (EP) 19185628.5

(51) Int. Cl. H04B 10/61; H04L 5/00; H04L 1/00

(52) U.S. Cl. CPC H04B 10/616; H04L 5/0046; H04L 1/0008; H04L 5/0007

(57) ABSTRACT

A modulator and demodulator for generating an Asymmetrically Clipped Optical, ACO, Orthogonal Frequency Division Multiplexing, OFDM, signal for use in data communication based on a data stream comprising input data symbols. said modulator comprising: an OFDM time signal generator block arranged for generating a time domain OFDM signal based on said input data symbols, a copy-and-flip block arranged for copying and flipping said time domain OFDM signal and appending said copied and flipped real-valued time domain OFDM signal to said time domain signal thereby obtaining a full time domain ACO-OFDM signal. The demodulator follows an inverse approach wherein an un-flip and merge block un-flips a second half of said ACO OFDM signal and merges the un-flipped second half of said ACO OFDM signal with a of said ACO OFDM signal, thereby obtaining a time domain ACO OFDM signal which is they used to retrieve the input data symbols.

### FIELD OF THE INVENTION

The present disclosure generally relates to the field of communication, in particular wireless communication or communication over a fibre, and, more specifically, to a modulator for generating an Asymmetrically Clipped Optical, ACO, Orthogonal Frequency Division Multiplexing, OFDM, signal as well as a corresponding demodulator.

### BACKGROUND OF THE INVENTION

Optical wireless communication, OWC, is a form of optical communication in which unguided visible, for example infrared or ultraviolet, light is used to carry a signal.

Systems that utilize optical wireless communication in the visible frequency band range, i.e. somewhere between 390 nm-750 nm, are commonly referred to as visible light communication, VLC, systems. These types of VLC systems take advantage of Light Emitting Diode's, LED's, which LED's can be pulsed at very high frequencies without any noticeable effect on the lighting output and without any effect perceivable for a user. Alternatively optical wireless communications may make use of (near) infrared, with a wavelength of 750 nm to 3000 nm.

VLC systems may be used in a wide range of applications, including wireless local area networks, LAN's, wireless personal area networks, PAN's, and vehicular networks among others.

Alternatively, terrestrial point-to-point OWC systems, which are also referred to as the free space optical, FSO, systems, typically operate at the near InfraRed, IR, frequencies, for example 750 nm-1600 nm. These types of systems typically use laser transmitters and offer a cost-effective protocol-transparent link with high data rates up to about 10 Gbit/s per wavelength and provide a potential solution for the backhaul bottleneck.

A growing interest is noticeable on ultraviolet communication, UVC, which operate within solar-blind UV spectrum, i.e. between 200 nm-280 nm.

It is commonly known that intensity modulation OWC or Intensity Modulation, IM, over fibre is not able to cope with signals with negative values, because intensities are by definition non-negative. This means that non-negative transmission signals are to be generated.

One of the transmission techniques that is used in OWC systems is Orthogonal Frequency Division Multiplexing, OFDM. In telecommunications, OFDM is a method of encoding data on a plurality of carriers, wherein the carriers are orthogonal to each other. An OFDM signals tends to be a complex signal which has both positive as well as negative parts.

The above has been recognized in the art, and multiple amendments to the traditional OFDM transmission techniques have been proposed. These amendments are directed to the generation of unipolar OFDM signals. As mentioned above, OWC systems are able to cope with unipolar OFDM signals.

Two popular unipolar OFDM systems are FLIP OFDM and ACO OFDM. Both systems are able to convert N Pulse amplitude Modulation, PAM, data symbols (or equivalently N/2 Quadrature Amplitude Modulation symbols) into 2N non-negative transmit samples, where mostly Nis a power of 2.

Both FLIP OFDM and ACO OFDM, explicitly or implicitly create an OFDM signal in which the second part is exactly a polarity-flipped replica of the first part. FLIP OFDM does this explicitly by repeating and polarity-flipping an OFDM block of length N. ACO OFDM does this implicitly by using an FFT of length 2N and only allowing signal dimensions that have the required period repetition, i.e. the odd subcarriers.

The paper “Flip-OFDM for Unipolar Communication Systems”, by Nirmal Fernando et al. published in IEEE Transactions on Communications vol. 60, no. 12 discloses unipolar OFDM techniques for use in optical or RF wireless systems. More in particular Flip-OFDM and ACO-OFDM are compared, showing that Flip-OFDM has a lower hardware complexity as compared to ACO-OFDM and how a negative clipper in conjunction with a threshold based noise filtering algorithm may be employed to lower the BER in a modified Flip-OFDM receiver.

The present disclosure focusses on an inventive architecture for an ACO OFDM modulator and demodulator.

### SUMMARY OF THE INVENTION

It would be advantageous to achieve a modulator for generating an Orthogonal Frequency Division Multiplexing, OFDM signal that can be deployed more versatilely, i.e. which is more flexible.

It would further be advantageous to achieve a method for generating an OFDM signal in a more flexible manner, such that it can be deployed in multiple unipolar wireless communication systems.

It would further be advantageous to generate an OFDM signal for OWC in a more efficient manner, such that it can consumes less power or occupies less memory.

To better address one or more of these concerns, a modulator is provided in accordance with claim 1, a demodulator in accordance with claim 8, a method for generating an asymetrically clipped optical OFDM signal in accordance with claim 13, a method for demodulating an symmetrically clipped optical OFDM signal in accordance with claim 14, a computer program product in accordance with claim 15 and a signal in accordance with claim 16.

In a first aspect of the disclosure, there is provided a modulator for generating an Asymmetrically Clipped Optical, ACO, Orthogonal Frequency Division Multiplexing, OFDM, signal for use in data communication based on a data stream comprising input data symbols, said modulator comprising:
an OFDM time signal generator block arranged for generating a time domain OFDM signal based on said input data symbols,
a copy-and-flip block arranged for copying and flipping said time domain OFDM signal and appending said copied and flipped real-valued time domain OFDM signal to said time domain signal thereby obtaining a full time domain ACO-OFDM signal. Notably the term “flip” here is used throughout to denote a polarity inversion.

It was found that the requirements on the OFDM time signal generator block may be loosened when a copy and flip operation is performed. This is explained in more detail here below.

Typically, the OFDM time signal generator block will comprise an inverse Fourier Transform generator block for performing an inverse Fourier Transform on provided subcarriers thereby providing time domain signals. FLIP OFDM and ACO OFDM differ in the way the inverse Fourier Transform generator block actually works.

FLIP OFDM utilizes an N sized inverse FFT for converting N/2 complex valued data symbols, in combination with N/2 “other” symbols, in total N symbols, into N time domain signals where the “other” signals are unambiguously related to the data symbols to enforce specific (real-valued) properties.

ACO OFDM typically utilizes a N sized inverse FFT for converting N/4 complex valued data symbols in combination with N/4 zeros and N/2 “other” symbols, in total N symbols, into N time domain signals. In existing literature, ACO OFDM is typically described to utilize a N sized inverse FFT for converting N/4 complex valued data symbols in combination with N/4 zeros and N/2 “other” symbols, in total N symbols, into N time domain samples. Yet, for the sake of intuitively introducing the line of thought behind the invention, we prefer to interpret this as this as: ACO OFDM typically utilizes a 2N sized inverse FFT for converting N/2 complex valued data symbols in combination with N/2 (complex) zeros (0+j0) and N “other” symbols, in total N real valued input data symbols, into 2N time domain samples.

Following the above, there is a ratio of 1:4 in an ACO OFDM modulator between data symbols (N/4, in terms of the typical prior art literature) and the size of the inverse FFT (N). The inventor has found that, by introducing a copy (and time shift of that copy) and flip operation on the time domain signal generated by the OFDM time signal generator block, the size of the inverse FFT may be reduced for the same amount of data symbols. The ratio between the data symbols and the size of the inverse FFT may be reduced to 1:2, i.e. for N/2 data symbols an inverse FFT operation may be performed of size N.

It is noted that the above modulator in accordance with the present disclosure may be used in all kinds of wireless communication devices, especially in communication devices that utilize real-valued or even unipolar transmission signals.

The modulator may, for example, be deployed in an optical communication system, wherein the optical communication system modulates the intensity of visible light, infrared light, or near ultraviolet light to communicate information.

Further, the modulator may be deployed in a dedicated access point, wherein the dedicated access point does not need to have a function of providing environmental lighting to a room, or in a user device, such as a smartphone or in an Internet of Things, IoT, device.

In an example, the OFDM time signal generator block comprises:
a subcarrier generator block arranged for generating N/2 consecutive subcarriers based on N/2 input data symbols,
a zero padding block arranged for consecutive padding said N/2 subcarriers with N/2 zeros, thereby obtaining N subcarriers;
an inverse Fourier Transform generator block arranged for performing an N sized inverse Fourier Transform on said N subcarriers thereby providing N time domain signals at an output;

wherein said modulator is arranged to convert said N time domain signals into a time domain OFDM signal, and wherein said modulator further comprises:
an extraction block arranged for extracting a real-valued part from an inputted complex-valued time domain signal, which block is connected to said output of said inverse Fourier Transform generator block, such that said converted time domain OFDM signal is a real-valued time domain OFDM signal.

In, for example, OFDM for intensity modulation, including DC-offset OFDM but also ACO OFDM and FLIP OFDM, a sequence of N real valued time-samples that carry N/2 consecutive subcarriers are generated based from N/2 complex-valued input data symbols. The remaining N/2 input data signals are generated by utilizing the Hermitian symmetry property. This implies that the symbol for subcarrier n, i.e. Xₙ, equals the complex conjugated symbol for subcarrier N−n, i.e. X_{N-n}*. This ensures that a real-valued signal is obtained after performing the inverse Fourier Transform.

The above described property implies that half of the OFDM subcarriers are sacrificed to generate the real-valued time domain OFDM signal. In fact, N/2 complex input signals, usually QAM, generate N real valued numbers, in an invertible manner, so the number of “dimensions” is equal, before and after the inverse Fourier Transform.

The inventor has found that the above described principle, or mechanism, for creating a real-valued OFDM signal may be superfluous. There may not be a need to actually utilize the Hermitian symmetry property for generating the remaining N/2 consecutive subcarriers. As such, there is no need to assure that Xₙ equals X_{N-n}*.

It was found that the remaining N/2 subcarriers may be generated by padding these with N/2 zeros. The result is that a complex-valued signal is obtained after performing the inverse Fourier Transform. However, a same real-valued signal, possibly except for a fixed multiplication by a factor of 2, may be obtained by ignoring the imaginary-valued part of the obtained complex-valued signal as was the case for the traditional mechanism for creating the real-valued OFDM signal.

The above described principle may be used for the generation of any real-valued OFDM signal, including OFDM over a cable in base band, as in ASDL or power line, for DC-offset OFDM on an Intensity Modulation fibre or OWC.

As such, a traditional real-valued OFDM modulator for generating a FLIP OFDM signal, or ACO OFDM signal, may also be amended in such a way that zeros are placed on the remaining N/2 subcarriers, instead of the complex conjugated symbols in accordance with the Hermitian symmetry property, and in that, after performing the inverse Fourier Transform, the imaginary-valued part of the signal is ignored. That is, the real-valued part of the complex-valued time domain signal after the inverse Fourier Transform is taken, i.e. isolated.

It is noted that, in accordance with the present disclosure, a real-valued signal may be extracted from the complex signal in various ways. Examples include, but are not limited to, taking the real part of the complex signal, taking the imaginary part, taking a linear combination of the real and imaginary part, or doing phase rotation and the taking the real part. In particular we include also operations in which the combination of real and imaginary part depends on a sample k. A prime example is a phase rotation that linearly increases with k, which will be explained in more detail here below.

The modulator in accordance with the present disclosure operates using N/2 input data symbols. It is noted that some of these N/2 input data symbols may be set to zero, for example the top 2, 3, 4, 5, or 6, input data symbols, for making a sharp spectral mask and to be able to make an aliasing filter.

It is further noted that, the example as described above is in fact an implementation for a modulator for generating a FLIP OFDM signal. The inventor has found that the same implementation may be used for generating an ACO OFDM signal by introducing a copy-and-flip block to the modulator.

In an example, the OFDM time signal generator block further comprises:
a Parallel to Serial, P/S, generator block for serializing said N time domain signals at said output into a time domain OFDM signal;

wherein said extraction block is connected to said P/S generator block such that said block takes a real-valued part of said serialized time domain OFDM signal.

It was noted that the extraction block should be placed somewhere behind the inverse Fourier Transform generator block. It may be placed directly behind the inverse Fourier Transform generator block in which case the extraction block is to operate on N different outputs from the inverse Fourier Transform generator block. The modulator may further serialize the outputs from the inverse Fourier Transform generator block, i.e. the N time domain signals, by using a P/S generator. In that case, the extraction block may also be connected to the output of the P/S generator.

In a further example, the OFDM time signal generator block further comprises:
a phase rotation block, connected in between said inverse Fourier Transform generator block and said extraction block, which phase rotation block is arranged for phase rotating an inputted complex-valued time domain signal thereby providing a phase rotated complex-valued time domain signal.

The phase rotation block may, for example, be arranged to phase rotate an inputted complex-valued time domain signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j. The particular choice for α=1, or 3, etc., may ensure specific properties of continuous phase. Without loss of generality, a fixed φ can be applied without losing any properties as disclosed in the present disclosure.

The present disclosure proposes a versatile modulator which can be used for creating an improved implementation for creating an ACO OFDM signal.

To do so, the modulator generates N/2 subcarriers based on N/2 input data symbols, for example Quadrature Amplitude Modulation, QAM, symbols. These generated, consecutive (in frequency), subcarriers are appended with an additional N/2 zero's, such that in total N subcarriers are generated. The N subcarriers are processed by an N-sized inverse Fourier Transform generator block for performing an N sized inverse Fourier Transform on said N subcarriers. After the inverse Fourier Transform a complex-valued time domain signal is obtained. In accordance with the present disclosure, a block is placed somewhere behind the inverse Fourier Transform generator block for extracting only the real-value part from a complex-valued time domain signal.

Thus, the present disclosure does not require the Hermitian Symmetry on the input signals, which is commonly used to ensure a real-valued signal for OWC. The above described principle may be used particularly for improving a FLIP

OFDM signal and creating an ACO-OFDM signal with lower complexity. In fact, the inventor has found that the presence of an imaginary part at the output of the inverse Fourier Transform in the above described principle has a further advantage that can be used for improving FLIP OFDM.

The inventor has further found that the above described principle may be used for creating an ACO OFDM signal with lower complexity. It was found that ACO OFDM is similar to FLIP OFDM in that all subcarriers are shifted one frequency grid-point upwards. This is equivalent to multiplying the time domain signal by a complex exponential, that mimics a frequency lift, for example of half a subcarrier (α=1). This is accomplished, in accordance with the present disclosure, with the phase rotation block.

Details with respect to the similarity are provided with respect to the description of the figures.

It is noted that the phase rotation block may be enabled, or disabled, by the modulator. In case the modulator intends to create a FLIP OFDM signal, the phase rotation block may be disabled. In case the modulator intends to create an ACO OFDM signal or an improved variant of FLIP OFDM, the phase rotation block may be enabled.

In a further example, the OFDM time signal generator block further comprises:
a subcarrier shifter block arranged for shifting said N subcarriers upwards in frequency by one half subcarrier spacing before performing said N sized inverse Fourier Transform by said inverse Fourier Transform generator block.

As mentioned above, it was found that a FLIP OFDM signal has similarities with an ACO OFDM signal. An ACO OFDM signal has subcarriers that are shifted one half subcarrier spacing upwards in frequency compared to a FLIP OFDM signal. Such a processing may be accomplished by multiplying a time domain signal, after the inverse Fourier Transform generation, with a complex exponential, or may be accomplished by shifting the N subcarriers upwards in frequency by one half subcarrier spacing before performing the N sized inverse Fourier Transform.

Following the above, the present implementation of the modulator may therefore actually resemble the implementation of a FLIP OFDM signal, wherein, additionally, the N subcarriers are shifted upwards in frequency by one half subcarrier spacing before performing the N sized inverse Fourier Transform (or the signal is phase rotate after the inverse Fourier Transform), and a copy and flip operation is performed. This results in an ACO OFDM signal.

In a further example, the modulator further comprises:
a Cyclic Prefix, CP, generator block arranged for generating a cyclic prefix to said full time domain ACO-OFDM signal.

A feature of ACO OFDM is that the subcarriers are by design continuous at the split between the two halves. So, the cyclic prefix and windowing are only needed at the beginning of the 2N frame, while FLIP OFDM would need cyclic prefixes and windowing at both halves.

The above described Cyclic prefix may thus be the Cyclic prefix at the end of the full time domain ACO-OFDM signal.

Preferably a modulator as disclosed herein above further comprises a modulation path for modulating a secondary signal into a second OFDM signal wherein the second OFDM modulated signal is added to the full time domain ACO OFDM signal and wherein the secondary OFDM signal comprises OFDM block-pairs having the same block size as the full time domain ACO signal and wherein the secondary OFDM signal comprises OFDM block-pairs and the second block of a respective OFDM block-pair is a cyclic continuation of the first block of the OFDM block pair.

Alternatively, a modulator as disclosed herein above further comprises a modulation path for modulating a secondary signal into a second OFDM signal wherein the second OFDM modulated signal is added to the full time domain Flip OFDM signal and wherein the secondary OFDM signal comprises OFDM block-pairs having the same block size as the full time domain Flip OFDM signal and wherein the secondary OFDM signal comprises OFDM block-pairs and the second block of a respective OFDM block-pair is a (not-polarity flipped) copy of the first block of the OFDM block pair. Preferably, the first block and second block of each respective OFDM block-pair are separated by an intermediate cyclic mid-fix, that is also introduced in the full time domain FLIP OFDM signal.

In a second aspect of the present disclosure, there is provided a demodulator for demodulating an asymmetrically Clipped Optical, ACO, Orthogonal Frequency Division Multiplexing, OFDM, signal for use in data communication based on a data stream comprising input data symbols, said demodulator comprising:
an un-flip and merge block arranged for un-flipping a second half of said ACO OFDM signal and for merging said un-flipped second half of said ACO OFDM signal with a first half of said ACO OFDM signal, for example by selecting the stronger signal, by adding with fixed identical weights or by adding while weighing stronger signals more heavily, thereby obtaining a time domain OFDM signal that can be handled with with reduced length;
an OFDM data symbol generator block for retrieving said complex input data symbols based on said obtained real-valued time domain OFDM signal with reduced length.

It is noted that the advantages and definitions as disclosed with respect to the examples of the first aspect of the invention, being the modulator, also correspond to the examples of the second aspect of the invention, being the demodulator.

In an example, OFDM data symbol generator block comprises:
an Fourier Transform generator block arranged for performing an N sized Fourier Transform on said OFDM signal with reduced length, thereby obtaining N subcarriers;
a data retrieve block arranged for retrieving N/2 input data symbol from said obtained N subcarriers.

In a further example, the OFDM data symbol generator block further comprises:
a Serial to Parallel, S/P, generator block for parallelizing said ACO OFDM signal with reduced length into N time domain signals for input to said Fourier Transform generator block.

In another example, the OFDM data symbol generator block further comprises:
a phase rotation block arranged for phase rotating a time domain OFDM signal thereby providing a phase rotated time domain OFDM signal for input to said Fourier Transform generator block.

In an example hereof, the phase rotation block is arranged to phase rotate a time domain OFDM signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j.

In this manner the complex-valued phase rotation introduces a single side band upshift in frequency by an integer multiple of half the subcarrier spacing, the combination of phase rotation and Fourier Transform may also be construed as a modified Fourier Transform.

In a further example, the OFDM data symbol generator block further comprises:
a subcarrier shifter block arranged for shifting said N subcarriers downwards in frequency by one half subcarrier spacing before performing said N sized Fourier Transform by said Fourier Transform generator block.

Preferably a demodulator as disclosed herein above further comprises a demodulation path for demodulating a secondary OFDM signal that was added to the ACO (or, alternatively to the Flip-) OFDM signal, and wherein the secondary OFDM signal comprises OFDM block-pairs having the same block size as the ACO (or Flip) OFDM signal and wherein the secondary OFDM signal comprises OFDM block-pairs and the second block of a respective OFDM block-pair is a copy of the first block of the OFDM block pair.

In a third aspect, there is provided a method for generating an Asymmetrically Clipped Optical, ACO, Orthogonal Frequency Division Multiplexing, OFDM, signal for use in data communication based on a data stream comprising input data symbols, said method comprising the steps of:
generating a time domain OFDM signal based on said input data symbols,
copying and flipping said time domain OFDM signal and appending said copied and flipped real-valued time domain OFDM signal to said time domain signal thereby obtaining a full time domain ACO-OFDM signal.

In an example, the step of generating further comprises:
generating N/2 consecutive subcarriers based on N/2 input data symbols,
consecutive padding said N/2 subcarriers with N/2 zeros, thereby obtaining N subcarriers;
performing an N sized inverse Fourier Transform on said N subcarriers thereby providing N time domain signals at an output;
converting said N time domain signals into a time domain OFDM signal, and wherein said modulator further comprises:
extracting a real-valued part from an inputted complex-valued time domain signal such that said converted time domain OFDM signal is a real-valued time domain OFDM signal.

In a further example, the method further comprises the step of:
serializing said N time domain signals into a time domain OFDM signal.

In another example, the step of generating further comprises:
phase rotating an inputted complex-valued time domain signal thereby providing a phase rotated complex-valued time domain signal.

In a further example, the step of phase rotating comprises phase rotating an inputted complex-valued time domain signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j.

In an example, the step of generating further comprises:
shifting said N subcarriers upwards in frequency by one half subcarrier spacing before performing said N sized inverse Fourier Transform.

In a fourth aspect, there is provided a method for demodulating an asymmetrically Clipped Optical, ACO, Orthogonal Frequency Division Multiplexing, OFDM, signal for use in data communication based on a data stream comprising input data symbols, said method comprising the steps of:
un-flipping a second half of said ACO OFDM signal and for merging said un-flipped second half of said ACO OFDM signal with a first half of said ACO OFDM signal, thereby obtaining a time domain ACO OFDM signal with reduced length;
retrieving said input data symbols based on said obtained time domain OFDM signal with reduced length.

In an example, the step of retrieving further comprises:
performing an N sized Fourier Transform on said OFDM signal with reduced length, thereby obtaining N subcarriers;
retrieving N/2 input data symbol from said obtained N subcarriers.

In a further example, the step of retrieving further comprises:
parallelizing said ACO OFDM signal with reduced length into N time domain signals.

In yet another example, the step of retrieving further comprises:
phase rotating a time domain OFDM signal thereby providing a phase rotated time domain OFDM signal.

In an example, the step of phase rotating comprises phase rotating an a time domain OFDM signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j.

In an example, the step of retrieving further comprises:
shifting said N subcarriers downwards in frequency by one half subcarrier spacing before performing said N sized Fourier Transform.

In a fifth aspect, there is provided a computer program product comprising a computer readable medium having instructions stored thereon which, when executed by a modulator or demodulator, cause said modulator or demodulator to implement a method in accordance with any of the examples as provided above.

In a sixth aspect, there is provided a time domain OFDM signal obtained by a method in accordance with any of the examples as provided above.

It is noted that the signal produced by the modulator in accordance with any of the previous examples may be detected with a detector known in the art, for example:
ACO-OFDM in which a 2N-sized FFT is used. Here, the received signal may be seen only on the lower half of the odd subcarriers.

In other words, the presented modulator may create signals that are compliant to signals described formally, e.g. in standard documents that prescribe the use of ACO-OFDM, such as the ITU G.9991 or G.vlc.

Further to the above, not only Flip OFDM and ACO-OFDM allow an implementation that uses a copy-flip-clip operation. Other modulation methods can benefit from this approach as well. The property, exploited by the invention is that the signals of the to-be-copied first block contain subcarriers that exhibit a specific property, more particularly that the phase of every subcarrier differs 180 degrees at the beginning and at the end of that first block. In this situation a copy-flip operation (doing another 180 degree rotation) is equivalent to a cyclic continuations without a phase discontinuity. Flip OFDM, in its original form does not exhibit this property. Therefore Flip-OFDM requires a mid-fix. With the zero-padding, inverse FFT and phase rotation this 180 phase difference property is created.

It is further noted that other methods to create a block of orthogonal signals can be used. One such other example is the full use of an N sized inverse FFT, fed with complex, preferably QAM values on all of its subcarriers, thus not only on the lower half. The inverse FFT output is then upmodulated by I and Q branches at a mixing frequency that equals half the original sampling rate (of the time signals at the FFT out output) plus an odd integer mₛ times one half of a subcarrier spacing. Here mₛ is preferably smaller than N. In fact mₛ can be as low as 1, but must be large enough to avoid lower frequencies being attenuated by the DC block in the modulator or detector, but small enough to effectively use frequencies at which the LED has low attenuation. This method can be attractive if a system has to be compliant with other OFDM based modulation technologies such as IEEE 802.11 (WiFi) like systems in which QAM symbols are modulated on all subcarriers, without imposing restrictions as regards a symmetry or zero-padding the upper half. So, in this example, up-modulation with a frequency of

$$( \frac{N}{2} + \frac{{m}_{s}}{2} ) {f}_{p}$$

can be used, for the outputs of the inverse FFT.

Here N is the FFT size and fₚ is the playout sampling frequency of the transmit time signal. Upsampling of the FFT outputs avoids aliasing. In such case, fₚ=Nᵤfₛ with upsampling ratio Nᵤ preferably equal to Nᵤ=4. For Nᵤ=2 outer subcarriers of the OFDM signal may alias if mₛ is too large, i.e., with mₛ=2 out-subcarrier should be left empty (zero).

$$Re Part \times cos ( ( 1 + \frac{{m}_{s}}{2 N} ) π \frac{{k}_{u}}{{N}_{u}} ) + Im Part \times sin ( ( 1 + \frac{{m}_{s}}{2 N} ) π k )$$

Here kᵤ describes the time samples in the upsampled time domain. And the RePart and ImPart are the inphase and quadrature phase signals at the inverse FFT output, after upsampling.

Distinct differences with the earlier zero padding approach and this systems are that:
The former (zero-padded FFT approach) creates ACO-OFDM and is particularly suitable for in ITU g.9991.
The latter (fully loaded FFT approach) creates a signal that also adheres to the 180 degree phase rotation property. It may particularly be suitable to reuse existing RF-carrier OFDM (such as IEEE 802.11-like) systems and hardware. In this case only post-process time-series signals are output by the inverse FFT.
The former does a Single Side Band upmodulation of real-valued signal, making use of that signal itself and its Hilbert Transform.
The latter does a Double-Side Band up conversion of two real valued streams on an inphase and quadrature carrier.
The former does a small up-conversion, of half a subcarrier.
The latter shifts by a large amount; i.e. more than half the signal bandwidth.

However, both former and latter have in common that they create a time signal in which every subcarrier exhibits a phase difference of 180 degrees between start and end.

Also disclosed is a modulator for generating a non-negative clipped optical, Orthogonal Frequency Division Multiplexing, OFDM, signal for use in data communication based on a data stream comprising complex input data symbols, said modulator comprising:
an OFDM time signal generator block comprising processing means arranged for generating a time domain OFDM signal based on said complex input data symbols, wherein the OFDM time signal generator block comprises:
   a subcarrier generator block arranged for generating upto and including N subcarriers based on complex input data symbols, the subcarrier generator block comprising:
      an inverse Fourier Transform generator block of size N arranged for performing an inverse Fourier Transform on said subcarrier-bound data symbols thereby providing N time domain signals at an output and
      a processing block arranged to ensure that on every used subcarrier a phase difference of 180 degrees is present between the first and the last sample of the N time output samples of said inverse FFT, creating an integer K multiple of N time samples, with K greater or equal to 1, preferably by means of using upsampling and a frequency shift or a phase rotation; and
a copy-and-flip block, accepting the signal from said subcarrier generator block, the copy-and-flip block comprising processing means arranged for copying and flipping said time domain OFDM signal by means of a polarity inversion and appending said copied and flipped real-valued time domain OFDM signal to said time domain signal thereby obtaining a full time domain OFDM signal and
a clip block comprising processing means arranged for clipping the full time domain OFDM signal to positive valued signal.

In practice the number of subcarriers N will be 512 or 1024 and K will be a relatively small integer where K equals 1, 2, 3 or 4, although higher values are not excluded per se.

The above presented method of creating ACO-OFDM, but also this broader class of non-negative OFDM with continuous phase at midpoint, can be used in hybrid DC-biased and unipolar OFDM systems, such as systems using ADO, HACO OFDM. In fact, these are the addition of two OFDM modulation methods, each of which can be generated by solutions disclosed here. To increase the spectrum efficiency, Asymmetrically clipped DC biased Optical OFDM, ADO-OFDM, transmits ACO-OFDM on the odd subcarriers and adds DCO-OFDM on the even subcarriers. Hybrid ACO-OFDM, HACO-OFDM, simultaneously uses ACO-OFDM on odd subcarriers and PAM-DMT on even subcarriers.

Also disclosed is a novel class of hybrid OFDM schemes. As well as specific self-interference mitigation measures, particularly beneficial for such hybrid OFDM schemes.

These and other aspects of the invention will be apparent from and elucidated with reference to the embodiment(s) described hereinafter.

### BRIEF DESCRIPTION OF THE DRAWINGS

FIG. 1 shows a block diagram of a FLIP Orthogonal Frequency Division Multiplexing, OFDM, modulator in accordance with the prior art;

FIG. 2 shows a block diagram of a ACO Orthogonal Frequency Division Multiplexing, OFDM, modulator in accordance with the prior art;

FIG. 3 shows a block diagram of a modulator in accordance with the present disclosure;

FIG. 4 shows another block diagram of a modulator in accordance with the present disclosure;

FIG. 5 shows a block diagram of a modulator in accordance with the present disclosure;

FIG. 6 shows another block diagram of a modulator in accordance with the present disclosure;

FIG. 7 shows a simplified block diagram of a demodulator in accordance with the present disclosure;

FIG. 8 shows a simplified block diagram of a Light Fidelity, LiFi, transmitter using a modulator in accordance with the present disclosure;

FIG. 9 shows a simplified block diagram of a dual system in accordance with an example of the present disclosure;

FIG. 10 shows a further simplified block diagram of a dual system in accordance with an example of the present disclosure;

FIG. 11A depicts a detailed block diagram of a preferred primary-signal-detection-block from FIG. 10;

FIG. 11B depicts a detailed block diagram of a preferred recreate-interfering-primary-signal block from FIG. 10;

FIG. 11C depicts a detailed block diagram of the secondary-signal-detection block from FIG. 10.

### DETAILED DESCRIPTION

A detailed description of the drawings and figures are presented. It is noted that a same reference number in different figures indicates a similar component or a same function of various components.

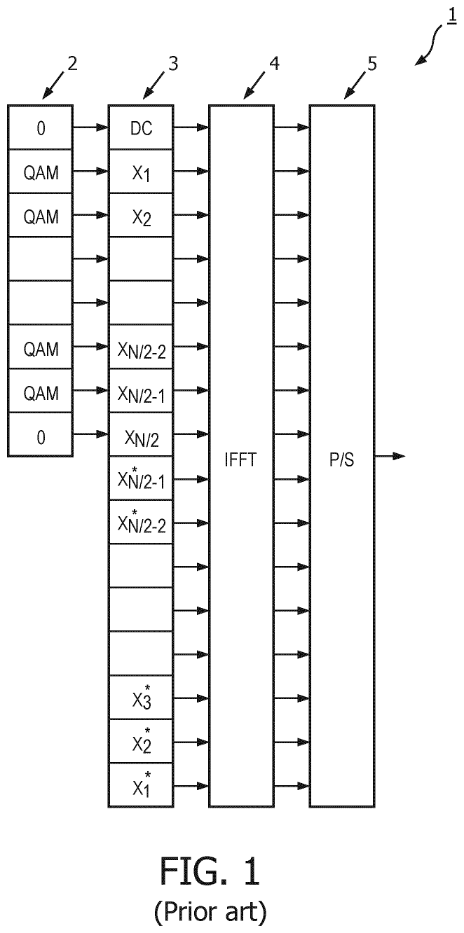

FIG. 1 shows a block diagram 1 of a FLIP Orthogonal Frequency Division Multiplexing, OFDM, modulator in accordance with the prior art. Reference numeral 2 denote the QAM symbols that are to be transmitted. It is trusted that any person in the art will be well aware of what QAM symbols are. As such, these types of symbols are not further explained in detail. Further details may however also be found in “Multi-Carrier Digital Communications: Theory and Applications of OFDM (Information Technology: Transmission, Processing and Storage)” 2^{nd} Edition, by Ahmad R. S. Bahai, et al, hereby incorporated by reference. It is further noted that the description here below refers to QAM symbols where the Inphase and Quadrature component independently carry data symbols. However, other modulation types may be used as well, for example, QAM in which bitmapping are used that mix the data across I and Q, or which more sophisticated signal constellations, or QPSK or BQPSK or anything alike.

Reference numeral 3 denote that symbols to be transmitted on the respective OFDM subcarriers. Notably in the figure X₀ is designated as “DC”, indicating that Xo corresponds to the DC component, which may be set to 0 to minimize power consumption. Here, Xₙ is the QAM symbol that is to be transmitted in the n-th subcarrier. The output of the inverse Fourier Transform, for example inverse Fast Fourier Transform or an inverse Discrete Fourier Transform, as indicated with reference numeral 4, at a k-th time instant is then given by:

$$x ( k ) = {\sum }_{n = 0}^{N - 1} {X}_{n} exp ( \frac{j 2 π k}{N} )$$

Here, N is the number of subcarriers, and thus also the size of the I-FFT, and j²=−1. In general, the (complex) symbols Xₙ that are to be transmitted over each OFDM subcarrier are not necessarily structured, such that the time-domain signal x(k) that is generated by the IFFT operation is a complex-valued time domain signal. Typically, already known real-valued OFDM mechanisms assure that the output is a real-valued time domain signal by imposing the Hermitian symmetry property at the input, meaning:

Xₙ=X_{N-n}*, wherein n=0, 1, 2, . . . , N/2

Here, the operator * denotes a complex conjugation. As mentioned above, this property implies that half of the OFDM subcarriers are sacrificed to generate a real time-domain signal at the output of the IFFT operation.

This is indicated with the bottom half of the column having reference numeral 3. The output of the IFFT block 4 is then serialized using a parallel to serial, P/S, generator block 5. The P/S generator block 5 may further be connected to other type of processing blocks for making the real-valued time domain signal adequate to be transmitted over an optical wireless communication link. For example, the signal is real-valued, but typically still bipolar. Which is solved by a copy (with time shift) and flip operation which is not explained in more detail with respect to FIG. 1.

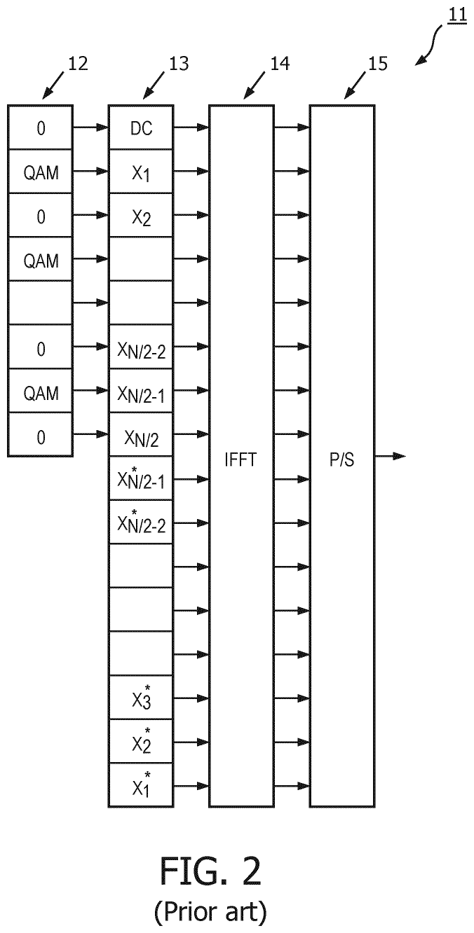

FIG. 2 shows a block diagram 11 of an ACO Orthogonal Frequency Division Multiplexing, OFDM, modulator in accordance with the prior art.

Here, reference numeral 2 indicates the QAM symbols, similar to the QAM symbols shown in FIG. 1. The difference is that the QAM symbols are interleaved with zeros, such that the QAM symbols are mapped onto the first half of only the odd subcarriers, as is shown with reference numeral 13. The even subcarriers are set to zero, i.e.

X₂ₙ₌₀, wherein n=0, 1, 2, . . . , N/2

Again, the Hermitian symmetry property is used, as explained before, to construct real-valued time domain signals at the output of the IFFT block generator 14, which are serialized using the P/S generator block 15.

The inventor has found that there is quite some similarity between a FLIP OFDM and an ACO OFDM signal, which is explained in more detail here below.

Both ACO and Flip OFDM systems convert N PAM data signals d₀ . . . d_{N-1} into 2N non-negative transmit samples, where mostly N is a power of 2. The process to reach these transmit signals is different, but the outcome has similarities. As a first step, in FLIP OFDM, N/2 complex valued QAM signals x₀, . . . , x_{N/2-1} are generated with xₙ=dₙ+j d_{N/2+n} where n=0, 1, . . . N/2−1. Other bit mappings may be used, but these are equivalent if we allow a renumbering of the symbols, without loss of generality. To create a real-valued output signal, it is common practice that these are extended into x_{N/2}, . . . , x_{N-1} to create an Hermitian-symmetric signal x_{N-k}=xₖ*, so xₙ=d_{N-n}−j d_{N-N/2+n} for n>N/2.

Details of the modulation of d₀ and d_{N/2} on the DC sub carrier and the maximum frequency subcarrier are well known to any skilled person, both of which are only one-dimensional and can carry only a single PAM symbol.

In Flip-OFDM, an N-sized FFT is performed on vector x=x₁, . . . X_{N-1}

$${z}_{k} = {\sum }_{n = 1}^{N / 2 - 1} [ ( {d}_{n} + j {d}_{\frac{N}{2} + n} ) {e}^{\frac{2 π j n k}{N}} + ( {d}_{n} - j {d}_{\frac{N}{2} + n} ) {e}^{\frac{2 π j ( N - n ) k}{N}} ] + …$$

Here the “+ . . . ” reflects specifically the two subcarriers 0 and N/2, which are omitted to avoid that these complicate the notation unnecessarily, while it does not give a deeper insight. Often, these two subcarriers are not participating in the data exchange, for instance because subcarrier 0 corresponds to a DC signal.

It should be clear from this expression that

$${d}_{n} + j {d}_{\frac{N}{2} + n}$$

in fact represents one QAM symbol, not necessarily with different bits on different I and Q dimensions, but that mixed constellations can also be captured in the above and following mathematical description.

What we learn from this is that the upper half of the subcarriers, used to satisfy the Hermitian symmetry with the first half, create the complex conjugate of the lower half at the output signal. Adding it to the lower half of the frequencies, this creates a real-only signal.

FLIP OFDM uses an explicit copy-and-flip operation, where the set of time samples between N and 2N−1 are polarity-flipped versions of the symbols between 0 and N−1 (z_{N+k}=−zₖ), so

$${z}_{k} = \{ \begin{matrix}{\sum }_{n = 1}^{N / 2 - 1} ( {d}_{n} + j {d}_{\frac{N}{2} + n} ) {e}^{\frac{2 π j n k}{N}} + & for k ∈ ( 0 , N - 1 ) \\ ( {d}_{n} - j {d}_{\frac{N}{2} + n} ) {e}^{- \frac{2 π j n k}{N}} & \\ - {\sum }_{n = 1}^{N / 2 - 1} ( {d}_{n} + j {d}_{\frac{N}{2} + n} ) {e}^{\frac{2 π j n ( k - N )}{N}} + & for k ∈ ( N , 2 N - 1 ) \\ ( {d}_{n} - j {d}_{\frac{N}{2} + n} ) {e}^{- \frac{2 π j n ( k - N )}{N}} & \end{matrix}$$

If we observe a specific subcarrier n in the above description, we see that there is a crude, undesirable, swap of polarity after k=N, where

$${e}^{\frac{2 π j n k}{N}} = {e}^{\frac{2 π j n N}{N}} = {e}^{2 π j n} = {1}^{n} = 1.$$

Yet the second line in the above expression contains a minus sign. In fact, this is equivalent to abruptly cutting off and changing the polarity of a running sinusoid. Translated in frequency-domain behavior, that generates wide sidebands, also outside the signal spectrum. In fact, it is similar to the effects that occur in OFDM where two successive block carry different QAM signals, potentially in opposite quadrants. As spectral widening effects mostly are undesirable, windowing is commonly used in OFDM. Windowing is equivalent to creating a smooth transition, between two blocks in which signal phases can be very different.

If instead a cyclic continuation into the OFDM block would were used, it would yield continuous phases at all subcarriers, while, in contrast to this, FLIP-OFDM continues in an anti-cyclic manner, as it suffers from the spectral widening by inserting a polarity flip. This may be mitigated by a transition period between the two halves to allow separate windowing of the two halves. As we will show next, this can be avoided without jeopardizing performance.

For an apples-to-apples comparison with the same number of symbols, it is appropriate to compare FLIP OFDM using two FFT blocks each of size N, to ACO-OFDM using a size 2N FFT in (or FLIP OFDM having a N/2 sized FFT block with ACO OFD having a N sized FFT block). ACO-OFDM typically uses a double sized FFT and it maps one complex valued QAM symbol, (here denoted as the n-th and (N/2+n)-th real valued data symbol) to subcarrier 2n+1 (i.e. an odd subcarrier) of the 2N-FFT. Interestingly, we observe that this is equivalent to a (virtual) subcarrier (n+^{1/2}) on a N-sized FTT. In fact, we see that for the 2N FFT

$${z}_{k} = {\sum }_{n = 1}^{N / 2 - 1} [ ( {d}_{n} + j {d}_{\frac{N}{2} + n} ) {e}^{\frac{2 πj ( 2 n + 1 ) k}{2 N}} + ( {d}_{n} - j {d}_{\frac{N}{2} + n} ) {e}^{\frac{2 π j ( 2 N - 2 n - 1 ) k}{2 N}}$$

If we insert

$${e}^{\frac{2 π j ( 2 n + 1 ) ( N + k )}{2 N}} = {( - 1 )}^{2 n + 1} {e}^{\frac{2 π j ( 2 n + 1 ) k}{2 N}} = - {e}^{\frac{2 π j ( 2 n + 1 ) k}{2 N}} ,$$

we observe that the property that the second half is a flipped copy of the first half, is satisfied automatically for ACO-OFDM, with

zₖ=−z_{N+k}

In other words, if we create an OFDM signal by firstly generating only N samples and then copy, shift in time over N positions and flip polarity, we arrive at an ACO signal, yet using a different recipe than used in the prior art.

The ACO-OFDM signal can be rewritten as an N sized FFT as

$${z}_{k} = {\sum }_{n = 0}^{N / 2 - 1} ( {d}_{n} + j {d}_{\frac{N}{2} + n} ) {e}^{\frac{2 π j ( n + \frac{1}{2} ) k}{N}} + ( {d}_{n} - j {d}_{\frac{N}{2} + n} ) {e}^{- \frac{2 π j ( n + \frac{1}{2} ) k}{N}}$$

for k=0, 1, . . . N−1, and a cyclic extension for k=N, N+1, . . . 2N−1. So in fact we found that the difference between Flip OFDM and ACO-OFDM is just a shift in frequency by half a subcarrier spacing. ACO-OFDM adheres to

$${z}_{k} = {\sum }_{n = 0}^{N / 2 - 1} ( {d}_{n} + j {d}_{\frac{N}{2} + n} ) {e}^{\frac{2 π jnk}{N}} {e}^{\frac{2 π jk}{2 N}} + ( {d}_{n} - j {d}_{\frac{N}{2} + n} ) {e}^{- \frac{2 π j n k}{N}} {e}^{- \frac{2 π j k}{2 N}}$$

Here the denominator in the complex exponential is N, not 2N, which allows implementation as an N sized FFT. Thus, we get ACO-OFDM by lifting the frequency of all subcarriers in Flip OFDM, by one half subcarrier spacing, which is the same as multiplying the output of samples after the TX FFT by

$$exp \pm \frac{π j k}{N} .$$

To facilitate an implementation, we also observe that, since (ab)*=a*b* and Re[2α]=α+α*, the samples zₖ to be transmitted may as well be written as

$${z}_{k} = Re [ 2 {\sum }_{n = 0}^{N / 2 - 1} ( {d}_{n} + j {d}_{\frac{N}{2} + n} ) {e}^{\frac{2 π jnk}{N}} {e}^{\frac{2 π jk}{N}} ]$$

In other words, we may not need to prepare the upper sub-carriers as an Hermitian symmetric copy of the lower ones; we may just remove the imaginary part at the FFT output.

In an example, the present disclosure thus proposes to not apply Hermitian symmetry at the FFT input but to leave all higher subcarriers as zeros. At the output of the FFT, every output value may be phase rotated by

$$exp \frac{π j k}{N} ,$$

thus a linear ramp up to 180 degrees at k=N. Then the Real part is taken.

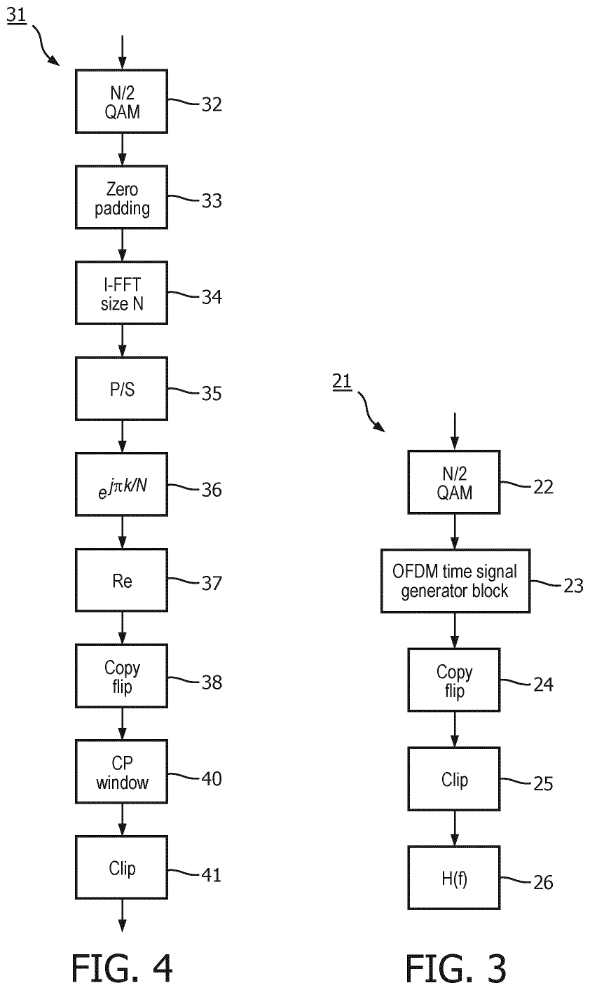

FIG. 3 shows a block diagram 21 of a modulator in accordance with the present disclosure.

Here, the block diagram 21 shows a modulator for generating an Asymmetrically Clipped Optical, ACO, Orthogonal Frequency Division Multiplexing, OFDM, signal.

The modulator comprising a subcarrier generator block 22 arranged for generating N/2 consecutive subcarriers based on N/2 input data symbols. Here, N/2 QAM symbols are used as an input to create N/2 subcarriers.

The OFDM time signal generator block is indicated with reference numeral 23. Here, the input data symbols are converted to a time domain OFDM signal using, for example, an inverse Fourier Transform.

One of the aspects of the present disclosure is the introduction of a copy and flip block 24 which is arranged for copying and flipping the time domain OFDM signal and appending the copied and flipped real-valued time domain OFDM signal to the time domain signal thereby obtaining a full time domain ACO-OFDM signal. In other words, a copy and flip action is introduced when construing an ACO-OFDM signal.

The output of the copy and flip block 24 may be coupled to a clip block 25 for clipping the signal before it is transmitted over a channel as indicated with reference numeral 26.

It is noted that the modulator in accordance with the present disclosure may be utilized in a variety of fields, for example in luminaires or other “infrastructure” devices such as OWC access points. The same approach can be used in end-point OWC devices that communicate with such infrastructure devices, such as laptops, smart phones, IoT devices or detachable peripherals (e.g. USB dongles). Notably the same approach may also be use in peer-to-peer (ad hoc) OWC networks. The time domain signal that is construed by the modulator is suitable to be used in light communications. As such, a Light Emitting Diode, LED, based lighting device is especially suitable.

The LED based lighting device may have a primary function of providing environmental lighting to a room and may have a secondary function of wireless communications utilizing a modulator in accordance with the present disclosure. The modulator may be used to modulate the light output of the general illumination device provided that the bandwidth requirements can be satisfied in this manner. Optionally LEDs without phosphors may be used to enable higher speeds. Alternatively, the modulator may be used to modulate the light output of infrared emitters, such as light emitting diodes, thereby obviating the need to switch on the illumination light to enable communication.

In another example, the modulator in accordance with the present disclosure is implemented in a communication device, for example in a router, switch, but also in a smoke detector, sprinkler system, or anything alike. In such a case, the communication device does not need to provide any environmental lighting. The LED's may then be dedicatedly used for communication. Notably, the LEDs may also be co-used for sensing.

Alternatively, a laser, such as a vertical-cavity surface-emitting laser, VCSEL, can be used for intensity-modulated OFDM optical communication with a modulator as disclosed in the present disclosure, likewise such lasers may also be co-used for sensing.

FIG. 4 shows another block diagram 31 of a modulator in accordance with the present disclosure.

Here, the blocks as indicated with reference numerals 33, 34, 35, 36 and 37 may be comprised by the block 23 as indicated in FIG. 3.

The zero padding block 33 is arranged for consecutive padding of the N/2 subcarriers with N/2 zeros, thereby obtaining N subcarriers. The inverse Fourier Transform generator block 34 is arranged for performing an N sized inverse Fourier Transform on the N subcarriers thereby providing N time domain signals at an output. A Parallel to Serial, P/S, generator block 35 is provided for serializing the N time domain signals at the output into a single time domain OFDM signal, and an extraction block 37 is provided which is connected to the P/S generator block 35 such that the block takes a real valued part of the serialized time domain OFDM signal.

The inventor has noted that ACO OFDM is very similar to FLIP OFDM, except that all subcarriers are shifted one frequency grid-point upwards. It appears that by shifting up, all subcarriers have a continuous phase halfway the frame, one can spectrally contain the signal better.

As such, in fact, in the above an implementation of a FLIP OFDM modulator is described. However, the introduction of the phase rotation block 36 make the signal that is created in fact an ACO OFDM signal. Although the shown modulator has many similarities to a FLIP OFDM modulator, the modulator is in fact arranged for generating an ACO OFDM signal.

Following the above, it may be advantageous if said phase rotation block is arranged to phase rotate an inputted complex-valued time domain signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j.

Whether or not to perform the phase rotating part of the present disclosure may thus be decided based on the actual intended transmission technique, for example FLIP OFDM or ACO OFDM.

Alternatively, to the phase rotating part after the IFFT, a subcarrier shifter block may be provided for shifting said N subcarriers upwards in frequency by one half subcarrier spacing before performing said N sized inverse Fourier Transform by said inverse Fourier Transform generator block.

So, in fact, for up-modulation with a frequency of, say α/2 we use, for the outputs:

$$Re Part \times cos ( \frac{π α k}{N} ) + Im Part \times sin ( \frac{π α k}{N} )$$

The modulator 31 further comprises a copy and flip operation 38 for making a real-valued time domain bipolar signal a real-valued time domain unipolar time domain signal, and it may comprise a clipping generator 41 for clipping the time-domain signal. The combination of these blocks makes the modulator suitable for generating an ACO OFDM signal.

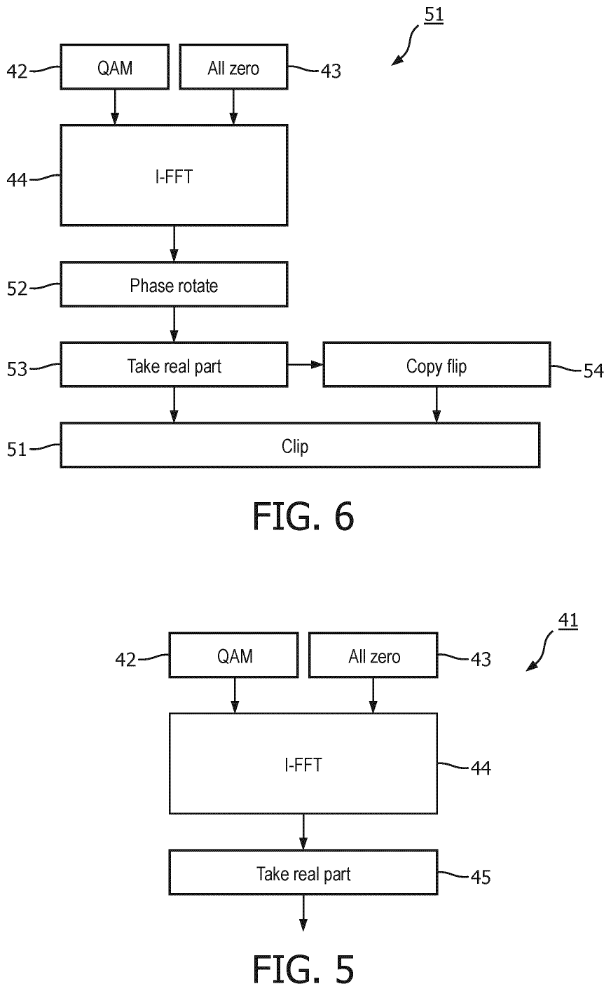

FIG. 5 shows a simplified block diagram of a modulator 41 in accordance with the present disclosure.

This figure is incorporated to visualize a concept of the present disclosure. As is shown, the QAM symbols 42 are extended with all zero's 43, and then an N-sized IFFT is performed 44. At the output of the IFFT 44, the real part is taken such that a real-valued time domain signal is obtained.

FIG. 6 shows an extended block diagram of a modulator 51 in accordance with the present disclosure.

The difference with the modulator shown in FIG. 5 is that at the output of the IFFT 44 a phase rotation 52 is performed for phase rotating the time domain signal. Only after performing the phase rotation, the real part 53 is taken and is copied and flipped 54 to assure that a unipolar signal is obtained. Finally, the time domain signal is clipped 55 and made ready for being transmitted. The thus modulated signal may be used as the control input for a high-bandwidth LED driver, that may be used to drive the LEDs of the Optical Wireless Communication device.

The light emitted by the Optical Wireless Communication device is subsequently received at a photo-sensitive receiver of an OWC receiving device, e.g. a diode receiver. The diode receiver converts the impinging light into an electrical signal which can be converted by means of an ADC into a signal that can be processed by the demodulator so as to demodulate the data signal comprised in the received optical signal.

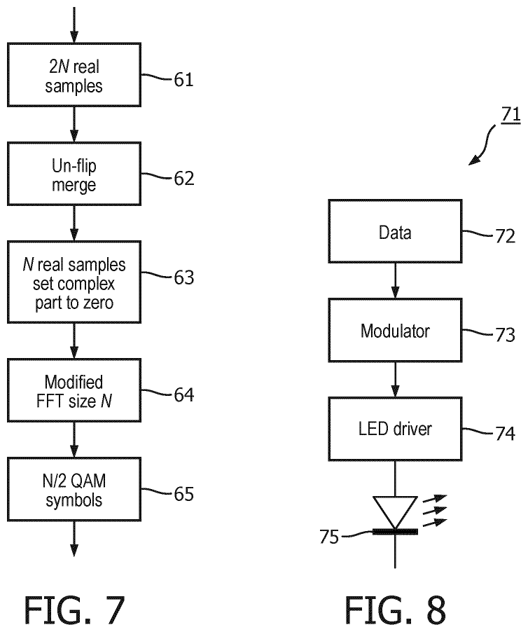

FIG. 7 shows an simplified block diagram of a demodulator, in accordance with the present disclosure.

It is noted that the detector may start with an operation that copies and adds the second half of the received N time samples ξₖ. Thus, this may constitute an unflip-and-merge operation to create the series of variables ξₖ−ξ_{N+k} for k=0, 1, . . . N−1. Although here referred to as “unflip”, so as to exemplify that it corresponds to reverting to the original state, the “unflip” operation is effectively a polarity inversion. To simplify the explanation, noise, dispersion and attenuation in the channel is omitted. Thus, for sake of explanation we write ξₖ=zₖ⁺ and ξ_{N+k}=z_{N+K}⁻, without channel, noise and amplification effects.

Inverting the previously mentioned operation, these are used as input to a N sized time-to-frequency transform, to create the output signal

$${ς}_{n} = {\sum }_{k = 0}^{N - 1} ( {ξ}_{k} - {ξ}_{N + k} ) {e}^{- \frac{2 π j ( n + \frac{1}{2} ) k}{N}}$$

The above expression is a modified FFT, as it has the same structure as a regular FFT, but with complex exponentials that have slightly higher phase rotation. Mathematically equivalent, but attractive in a practical implementation, is to rewrite the above expression as

$${ς}_{n} = F F T ( ( {ξ}_{k} - {ξ}_{N + k} ) {e}^{- \frac{π j k}{N}} )$$

That is, one can implement to ACO demodulator by unflip-and-merge operation to create the series of variables ξₖ−ξ_{N+k}, having length N. Then, every such real-valued time sample is multiplied by the complex-valued phase rotation

$${e}^{- \frac{π j k}{N}} .$$

This can be interpreted as a linearly increasing phase that grows from zero to 180 degree over the duration of the OFDM block. It can also be seen as a single-side band shift in frequency by half a subcarrier frequency spacing. The resulting phase-rotated time samples are fed into a FFT to recover the data symbols.

It is observed that in ACO-OFDM, zₖ=zₖ⁺−z_{N+k}⁻.

So, denoting m as the transmit subcarrier and n as the received subcarrier, after inserting the formula for the creation of an ACO-OFDM signal, it is observed that

$${ς}_{n} = {\sum }_{k = 0}^{N - 1} ( {\sum }_{m = 0}^{N / 2 - 1} ( {d}_{m} + {jd}_{\frac{N}{2} + m} ) {e}^{\frac{2 π j ( m + \frac{1}{2} ) k}{N}} + ( {d}_{m} - {jd}_{\frac{N}{2} + m} ) {e}^{- \frac{2 π j ( m + \frac{1}{2} ) k}{N}} ) {e}^{- \frac{2 π j ( n + \frac{1}{2} ) k}{N}}$$

Or, equivalently

$${ς}_{n} = {\sum }_{k = 0}^{N - 1} ( {\sum }_{m = 0}^{N / 2 - 1} ( {d}_{m} + j {d}_{\frac{N}{2} + m} ) {e}^{\frac{2 π j ( m - n ) k}{N}} + ( {d}_{m} - j {d}_{\frac{N}{2} + m} ) {e}^{- \frac{2 π j ( m + n + 1 ) k}{N}} )$$

Where in fact the first terms under the double sum reflects the lower subcarriers while the second term will create Hermitian symmetric outputs at the upper subcarriers.

Because of orthogonality of the subcarriers, the terms with n=m remain for the first sum of terms, and also the terms remain where m+n+1 forms an integer multiple of 2 for the second term.

For n<N/2, which is the relevant part of the FFT output, we recover the data, except for a constant multiplicative factor, because

$${ς}_{n} = \{ \begin{matrix}N ( {d}_{n} + j {d}_{\frac{N}{2} + n} ) & for n < N / 2 \\ M ( {d}_{N - n - 1} - j {d}_{N - \frac{N}{2} - n - 1} ) & for \frac{N}{2} < n < N\end{matrix}$$

where

$${d}_{n} + j {d}_{\frac{N}{2} + n}$$

represents the complexed valued QAM input signals used at the transmitter.

Thus, it is shown above that the ACO-signal can be recovered using a transform of size N, while previously ACO OFDM detection was known as taking odd subcarriers in an FFT of size 2N.

The above is indicated in FIG. 7, with the subsequent reference numerals 61, 62, 63, 64, 65.

The above describes the recipe for processing received signals. Here below, it is described that the signals are recovered correctly, by inserting the expression for the transmit signal, expressed in data symbols.

It is observed that in Flip and ACO-OFDM, zₖ=zₖ⁺−z_{N+k}⁻, So, since the receiver sees ξₖ=zₖ⁺ and ξ_{N+k}=z_{N+k}⁻ and subtracts these, it recovers ξₖ−ξ_{N+k}=zₖ

So, denoting m as the transmit subcarrier and n as the received subcarrier, after inserting the formula for the creation of an ACO-OFDM signal zₖ, it is observed that

$${ς}_{n} = {\sum }_{k = 0}^{N - 1} ( {\sum }_{m = 0}^{\frac{N}{2} - 1} ( {d}_{m} + {jd}_{\frac{N}{2} + m} ) {e}^{\frac{2 π j ( m + \frac{1}{2} ) k}{N}} + ( {d}_{m} - {jd}_{\frac{N}{2} + m} ) {e}^{- \frac{2 π j ( m + \frac{1}{2} ) k}{N}} ) {e}^{- \frac{2 π j ( n + \frac{1}{2} ) k}{N}}$$

Or, equivalently

$${ς}_{n} = {\sum }_{k = 0}^{N - 1} ( {\sum }_{m = 0}^{\frac{N}{2} - 1} ( {d}_{m} + j {d}_{\frac{N}{2} + m} ) {e}^{\frac{2 π j ( m - n ) k}{N}} + ( {d}_{m} - j {d}_{\frac{N}{2} + m} ) {e}^{- \frac{2 π j ( m + n + 1 ) k}{N}} )$$

Where in fact the first terms reflect the lower subcarriers while the second term will create Hermitian symmetric outputs at the upper subcarriers.

Because of orthogonality of the subcarriers, only the terms with n=m remain for the first sum of terms, and also the terms remain where m+n+1 forms an integer multiple of 2π for the second term.

For n<N/2, which is the relevant part of the FFT output, the data is recovered, except for a constant multiplicative factor, because

$${ς}_{n} = \{ \begin{matrix}N ( {d}_{n} + j {d}_{\frac{N}{2} + n} ) & for n < \frac{N}{2} \\ M ( {d}_{N - n - 1} - j {d}_{N - \frac{N}{2} - n - 1} ) & for \frac{N}{2} < n < N\end{matrix}$$

Thus, it is showed that ACO-signal can be recovered using only a transform of size N, while previously ACO OFDM detection was known as taking odd subcarriers in an FFT of size 2N.

FIG. 8 shows a simplified block diagram 71 of a Light Fidelity, LiFi, transmitter using a modulator in accordance with the present disclosure.

First, data 72 is generated, or construed, or provided to the modulator 73. The data may thus form the input data stream, and it may constitute the data the LiFi transmitter intends to transmit to a LiFi receiver. Such data may e.g. originate from a higher layer such as the Medium Access Control layer (MAC layer) of a larger communication stack where the data has been packaged in accordance with a communication protocol such as those from the IEEE and/or the ITU. The modulator 73 modulates the data 72 and generates a time domain OFDM signal. The time domain OFDM signal is used as an input to a Light Emitting Diode, LED, driver 74 for driving the one or more LED's 75. The LEDs in turn will emit the modulated light, which in embodiments may be illumination light, or alternatively infrared light.

It is noted that the modulator in accordance with the present disclosure may be advantageously used in optical wireless communication systems, such a LiFi systems. However, the presented modulator may be used in a variety of different communication systems, not excluding fiber communication or radio communication.

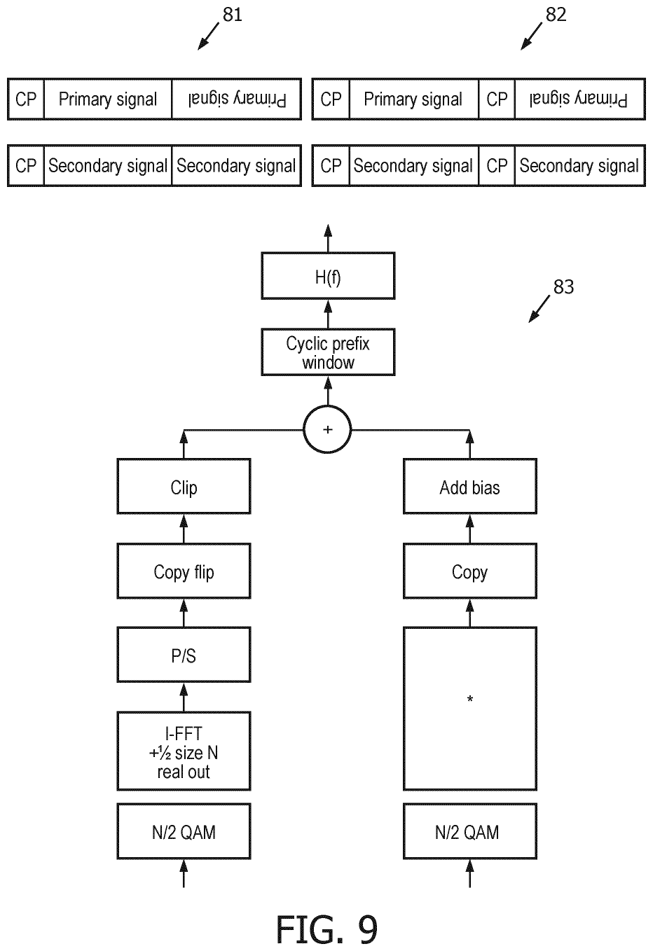

FIG. 9 shows a simplified block diagram of dual system as well as of time sequence structures 81, 82.

Clipped OFDM modulation, such as ACO-OFDM and Clip-OFDM, have the generic disadvantage that two consecutive OFDM blocks are needed to transmit the data that is initially already contained in a single block, before clipping. Hence the spectral efficiency is reduced by a factor of two. This can be repaired by adding a second DC biased signal that is periodic with the period of a single OFDM block, thus having an identical the first and second, copied block.

The above is visualized in the dual OFDM time sequence structures having reference numerals 81 and 82. Here, it can be seen that the primary signals are copied and flipped such that two consecutive OFDM blocks are created. Another DC biased signal that is periodic with the period of the primary signal OFDM block is introduced, being the secondary signal. The secondary signal is copied, but not flipped, into the second block. Both OFDM time sequence structures are added as will be discussed next with reference to block 83.

Block 83, in FIG. 9 discloses a new recipe for creating ACO-based hybrid OFDM signals. In particular it can be used for ADO-OFDM, which is a technique that combines aspects of ACO-OFDM and DCO-OFDM by simultaneously transmitting ACO-OFDM on the odd subcarriers and DCO-OFDM on the even subcarriers of an FFT of size 2N. Following the insights described earlier in the document, it can thus alternatively be created by using the time sequence structure of 81. Hence, ADO can be created alternatively by using a N-sized FFT on a primary signal, and doing a phase rotation to get the half-subcarrier uplift, a copy-flip-clip operation (creating ACO-OFDM), and adding a secondary signal also using an N-sized FFT after which copy operation is applied and a DC shift to make is non-negative (creating two blocks of DCO-OFDM). Because of the continuous phase property, a cyclic prefix is not necessary for this form of ADO-OFDM.

Moreover, the OFDM time sequence 82, discloses a new class of Hybrid OFDM schemes based on Flip-OFDM which have not previously been evaluated in literature. In fact, it somewhat resembles the above ADO-scheme but differs in that it does not have the phase continuity between the two blocks. One can still add a secondary signal that is identical in the two successive blocks. Yet here an intermediate cyclic mid-fix (indicated as CP between the blocks) is needed, if the channel is dispersive

Preferably, the primary signal is a Flip-OFDM signal, while the secondary signal is any other OFDM signal, that is copied (but not flipped) into the second block and a cyclic Prefix is applied in between the two copies. More preferably, the secondary signal is a DCO-OFDM signal, copied into two identical, sequential blocks. Even more preferably, the cyclic prefixes, including the one in between the first and second block, are combined with a windowing transition, as is commonly used in normal OFDM, between two different data blocks. The structure of block 83 can, thus, not only be used as a novel implementation of creating ADO-OFDM, it can also be used for further types of hybrid OFDM, for instance to improve the spectrum efficiency of Flip-OFDM.

At the transmitter an FFT for a single block may be used, thus of half the size used for ACO-OFDM, but preferably an FFT that has the ability to shift up the subcarrier frequencies by half a subcarrier spacing. A possible approach at the transmitter is to zero-pad the higher subcarriers and to use a linear increasing phase rotation in the time domain. Then a copy-flip-clip operation is performed.

Secondly, real signal of a duration of N samples is created, which is cyclically extended over a period of 2N, or more if further cyclic prefixes and postfixes are added. This secondary signal can be an OFDM signal that uses the same subcarrier spacing as the Flip OFDM, but there is not a necessary restricting property of the OFDM grid to be used here. In fact, even a “single carrier” secondary signal may work as well, instead of an OFDM secondary signal, as long as the similarity property of the first and second block is maintained.

The realization, i.e. implementation, of such a dual system is indicated with reference numeral 83. Here, the primary signal is created out of N/2 QAM symbols which are fed to an inverse FFT that is capable of shifting each of the subcarriers by a half subcarrier spacing upwards in frequency. The output of the inverse FFT is then serialized and copied and flipped to create the two consecutive OFDM blocks, before it is clipped.

The secondary signal is created out of another N/2 QAM signals. In this case, the secondary signal should have the same period as the primary signal but does not need to use the same subcarrier spacing, or even single carrier modulation. This is indicated with the “*”. At the output, the secondary signal would also need to be copied, but not flipped, and a bias is to be added. Both the primary signal and the secondary signal are then added up and a cyclic prefix is introduced before the signal is transmitted over the channel H(f).

Following the above, it was recognized that for ACO-OFDM, a non-clipped signal on even subcarriers does not cause interference to the recovery of the clipped signal (=primary signal) on the odd subcarriers in ACO-OFDM.

A problem with recovering the secondary signal may occur. Clipping artefacts from the copy-flip-clipping may cause interference to the secondary signal, i.e. inter-carrier interference.

As a countermeasure, the receiver could take the two blocks and subtract these sample by sample, i.e. flip second part, overlay on first block and subtract. This may cancel the periodic secondary signal. In fact, that cancellation of the secondary signal may even work if the channel is selective, and cancellation can be much improved by using a cyclic prefix before the first block.

The second block may be a cyclic extension of the first block, so any delayed signals from the first block that fall into the second block automatically act as cyclic extensions and do not cause artefacts.

This may create a clean, unclipped single block of the primary Flip OFDM signal, more specifically a Continuous Phase Flip OFDM signal. If the channel had a flat phase and amplitude response, thus if no dispersion occurred, this time-domain signal can be copied-flipped and clipped again to create a clean copy of the transmit signal that can be subtracted from the received signal to recover a clean secondary signal, clean of clipping artefacts.

Yet if the channel is selective, the received primary signal can still be reconstructed accurately. It can be detected by converting it to a frequency domain signal, equalized per subcarrier by correcting for the amplitude and phase at that frequency.

Different options exist with such equalized signals: Firstly, the primary signal can be detected. Secondly it can be used to clean up the received signal to improve the reception of the secondary signal.

For this second aim, it is converted back to time-domain samples, then copy-flip-clipped, before subtracted from the receive signal. The estimated channel, needed as part of this interference cancellation may be available as part of the OFDM detection of the primary signal, that is preferably the channel estimation is performed on the primary signal, and the this estimate is used to reconstruct the received interference (jointly using the estimated transmit signal and the estimated channel) and subtract this from incoming samples.

Channel estimation of an OFDM signal is well-known and commonly used in state-of-art, and not further elaborated upon. Typically, a channel inverse compensation based on a channel estimate. i.e., the per-subcarrier equalization is performed during the detection before the primary signal is sent to the level slicer.

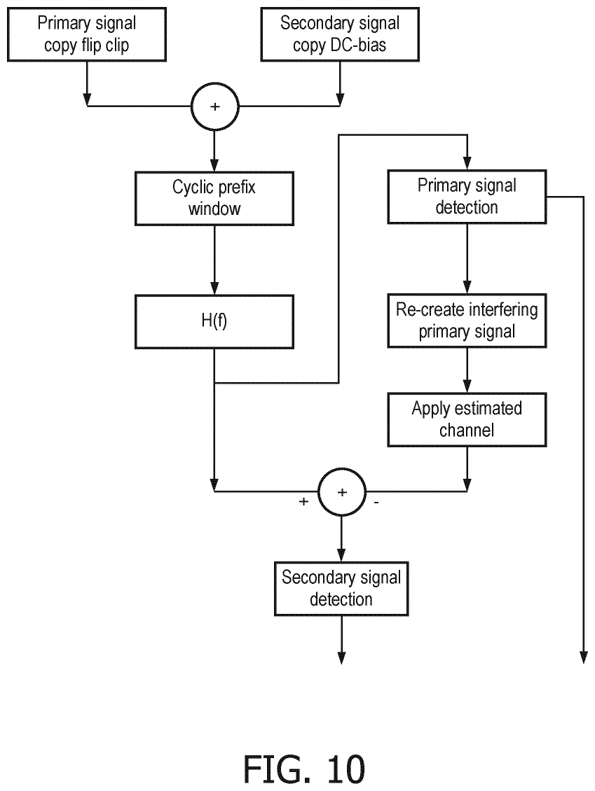

The above is shown, schematically, in the simplified block diagram shown in FIG. 10. More advanced equalizers are envisaged that also correct for non-linearities, for instance of the LED, such corrections may also be used as part for the reconstruction.

The first part of the block diagram is directed to the dual clip and bias aspects of the present disclosure. That is, a primary signal is created with a copy, flip and clip operation, and a second signal is added thereto which utilizes a copy and not a flip operation. A cyclic prefix window is inserted before the signal is transmitted over the channel, analogously to the dual system 83.

At the receiver/demodulator side, different aspects are performed. First, the primary signal detection is arranged to flip, and merge, both blocks of the signal to re-construct the primary signal carried by the clipped OFDM signal.

That primary signal is also fed back to a “Re-create interfering primary signal block”. The re-created primary signal is then fed through the estimated channel transfer. The output of the channel estimate is used for correcting the received signal for artefacts that occurred due to the clipping. Then, the secondary signal detection block is introduced which is arranged for re-constructing the secondary signal carried by the DC biased OFDM signal. That is, the second block of the OFDM signal is copied, not flipped, and merged with the first part, thereby cancelling the primary signal and amplifying the secondary signal.

The interference cancellation can take as input the subcarrier signals, with noise, as retrieved from the primary signal before slicing and error correction decoding. An improved step is to detect the data as quantized QAM signals, and to feed it to the interference estimation circuit. A further improved method is to also apply error correction decoding, then map the bits back to the QAM constellation and feed this cleaned, corrected signal into the interference estimation and cancelling circuit.

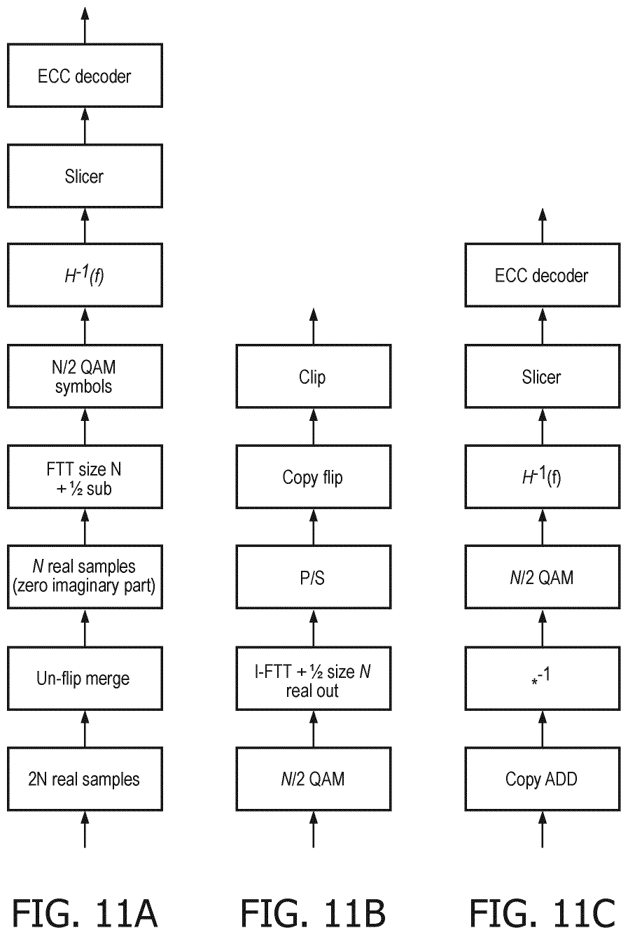

The block diagram in FIG. 10 shows that the primary signal may be used as an input for error correction of the secondary signal. The block diagram of FIG. 11A depicts a preferred embodiment of the primary signal detection block from FIG. 10. The block diagram of FIG. 11B depicts a preferred embodiment of the recreate interfering primary signal block of FIG. 10. FIG. 11C depicts an embodiment of the secondary signal detection block from FIG. 10.n

Although as described herein above, preferably the channel information based separation is performed in conjunction with the ACO OFDM modulation and demodulation as described herein, the channel-information-based separation as described herein with reference to the FIGS. 10 and 11 can also be used in conjunction with the prior art approach for decoding ACO OFDM. That is, the proposed application of the estimated channel can also be used to better predict the self-interference from the primary signal, regardless of whether one follows

the preferred approach of the disclosure (unflip-merge-FFT of size N for the primary signal and merge-FFT-of-size for the secondary signal, resp.) or

the approach known in the art, where the primary signal detection occurs by using an FFT of size 2N, thus using all received time samples (without unflip-merge) while the odd subcarriers at the output of the FFT are considered.

Following the prior art decoding, the initial, first estimate (still containing interference) of the secondary signal can be obtained from the even FFT outputs of that FFT operation. The secondary signal detection, after estimating, converting to time-domain, and cancelling interference, occurs by using an FFT of size 2N. and using as input all received time samples (no merging before the FFT), minus the estimated self-interference.

Regardless which approach is used, the estimated self-interference is calculated from the primary signal, reconstructed as an ACO-OFDM Signal and subjected to the estimated channel response. At the FFT output, the even subcarriers are considered to reconstruct the secondary signal.

Disclosed is a modulator for generating a non-negative clipped optical, Orthogonal Frequency Division Multiplexing, OFDM, signal for use in data communication based on a data stream comprising input data symbols. The modulator exploits the property, whereby a phase of every subcarrier differs 180 degrees at the beginning and at the end of that first block, which is addressed using a copy-flip-clip option.

In case of ACO, said modulator comprises an OFDM time signal generator block arranged for generating a time domain OFDM signal based on said input data symbols, a copy-and-flip block arranged for copying and flipping said time domain OFDM signal and appending said copied and flipped real-valued time domain OFDM signal to said time domain signal thereby obtaining a full time domain ACO-OFDM signal. Preferably said OFDM time signal generator block comprises: a subcarrier generator block arranged for generating N/2 consecutive subcarriers based on N/2 input data symbols, a zero padding block arranged for consecutive padding said N/2 subcarriers with N/2 zeros, thereby obtaining N subcarriers; an inverse Fourier Transform generator block arranged for performing an N sized inverse Fourier Transform on said N subcarriers thereby providing N time domain signals at an output; wherein said modulator is arranged to convert said N time domain signals into a time domain OFDM signal, and wherein said modulator further comprises: an extraction block arranged for extracting a real-valued part from an inputted complex-valued time domain signal, which block is connected to said output of said inverse Fourier Transform generator block, such that said converted time domain OFDM signal is a real-valued time domain OFDM signal.

The claimed invention may be implemented on a general-purpose processor, a controller, a dedicated application specific instruction set processor, application specific integrated circuit and/or combinations thereof, which implementation is most desirable will, in part, be determined by the throughput requirements and/or the implementation platform. For example the zero padding and or extraction functions as claimed are more akin to functionality that may be implemented using a general purpose processor or controller, whereas fixed/low-level configurable signal processing operations, such as, but not limited to Fourier Transforms, generally benefit from implementations in custom hardware as these typically achieve better performance per Watt compared to more programmable platforms.

In various implementations as envisaged, a processor or controller may be associated with one or more storage media (generically referred to herein as “memory,” e.g., volatile and/or non-volatile computer memory such as RAM, PROM, EPROM, and EEPROM, optical disks, hard disc drives, solid state drives, etc.).

As discussed hereinabove, preferably the modulators and demodulators as disclosed herein are used within Optical Wireless Communication devices in order to modulate and conversely demodulate the data to be transmitted.

In implementations, some of the storage media may be encoded with one or more programs that, when executed on one or more processors and/or controllers, perform at least some of the functions discussed herein. Various storage media may be fixed within a processor or controller, or in communication with the processor and/or controller. Alternatively, some media may be transportable, such that the one or more programs stored thereon can be loaded into a processor or controller so as to implement various aspects of the present invention discussed herein.

The terms “program” or “computer program” are used herein in a generic sense to refer to any type of computer code (e.g., software or microcode) that can be employed to program one or more processors or controllers.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope thereof.

1. A modulator for generating an Asymmetrically Clipped Optical, ACO, Orthogonal Frequency Division Multiplexing, OFDM, signal for use in data communication based on a data stream comprising complex input data symbols, said modulator comprising:
an OFDM time signal generator block comprising processing means arranged for generating a time domain OFDM signal based on said complex input data symbols, wherein the OFDM time signal generator block comprises:
a subcarrier generator block arranged for generating N/2 consecutive subcarriers based on N/2 complex input data symbols;
a zero padding block arranged for consecutive padding said N/2 subcarriers with N/2 zeros, thereby obtaining N subcarriers; and
an inverse Fourier Transform generator block arranged for performing an N sized inverse Fourier Transform on said N subcarriers thereby providing N time domain signals at an output;
a copy-and-flip block comprising processing means arranged for copying and flipping said time domain OFDM signal by means of a polarity inversion and appending said copied and flipped real-valued time domain OFDM signal to said time domain signal thereby obtaining a full time domain ACO-OFDM signal; and
a clip block comprising processing means arranged for clipping the full time domain ACO-OFDM signal to a positive valued signal.

2. The modulator in accordance with claim 1,
wherein said modulator is arranged to convert said N time domain signals into a time domain OFDM signal, and wherein said modulator further comprises:
an extraction block arranged for extracting a real-valued part from an inputted complex-valued time domain signal, which block is connected to said output of said inverse Fourier Transform generator block, such that said converted time domain OFDM signal is a real-valued time domain OFDM signal.

3. The modulator in accordance with claim 2, wherein said OFDM time signal generator block further comprises:
a Parallel to Serial, P/S, generator block for serializing said N time domain signals at said output into a time domain OFDM signal;
wherein said extraction block is connected to said P/S generator block such that said block takes a real-valued part of said serialized time domain OFDM signal.

4. The modulator in accordance with claim 2, wherein said OFDM time signal generator block further comprises:
a phase rotation block, connected in between said inverse Fourier Transform generator block and said extraction block, which phase rotation block is arranged for phase rotating an inputted complex-valued time domain signal thereby providing a phase rotated complex-valued time domain signal.

5. The modulator in accordance with claim 4, wherein said phase rotation block is arranged to phase rotate an inputted complex-valued time domain signal by:
φe^{jπαk/N}
wherein k indicates a k-th time instant of said OFDM signal, and α is a real-valued constant, preferably α=1, and wherein ϕ is a constant complex-valued phase, preferably ϕ=1 or ϕ=±j.

6. The modulator in accordance with claim 2, wherein said OFDM time signal generator block further comprises:
a subcarrier shifter block arranged for shifting said N subcarriers upwards in frequency by one half subcarrier spacing before performing said N sized inverse Fourier Transform by said inverse Fourier Transform generator block.

7. The modulator in accordance with claim 6, wherein said modulator further comprises:
a Cyclic Prefix, CP, generator block arranged for generating a cyclic prefix to said full time domain ACO-OFDM signal.

8. A demodulator for demodulating an asymmetrically Clipped Optical, ACO, Orthogonal Frequency Division Multiplexing, OFDM, signal for use in data communication based on a data stream comprising complex input data symbols, said demodulator comprising:
an un-flip and merge block arranged for un-flipping a second half of said ACO OFDM signal by means of polarity inversion and for merging said un-flipped second half of said ACO OFDM signal with a first half of said ACO OFDM signal, thereby obtaining a real-valued time domain OFDM signal with reduced length;
an OFDM data symbol generator block for retrieving said complex input data symbols based on said obtained time domain OFDM signal with reduced length, the OFDM data symbol generator block comprising:
an Fourier Transform generator block arranged for performing an N sized Fourier Transform on said ACO OFDM signal with reduced length, thereby obtaining N subcarriers; and
a data retrieve block arranged for retrieving N/2 complex input data symbol from said obtained N subcarriers.

9. The demodulator in accordance with claim 8, wherein said OFDM data symbol generator block further comprises:
a Serial to Parallel, S/P, generator block for parallelizing said ACO OFDM signal with reduced length into N time domain signals for input to said Fourier Transform generator block.

10. The demodulator in accordance with claim 8, wherein said OFDM data symbol generator block further comprises:
a phase rotation block arranged for phase rotating a time domain OFDM signal thereby providing a phase rotated time domain OFDM signal for input to said Fourier Transform generator block.

11. The demodulator in accordance with claim 10, wherein said phase rotation block is arranged to phase rotate a time domain OFDM signal by:
φe^{jπαk/N}
wherein k indicates a k-th time instant of said OFDM signal, and α is a real-valued constant, preferably α=1, and wherein ϕ is a constant complex-valued phase, preferably ϕ=1 or ϕ=±j.

12. The demodulator in accordance with claim 8, wherein said OFDM data symbol generator block further comprises:
a subcarrier shifter block arranged for shifting said N subcarriers downwards in frequency by one half subcarrier spacing before performing said N sized Fourier Transform by said Fourier Transform generator block.

13. A method for generating an Asymmetrically Clipped Optical, ACO, Orthogonal Frequency Division Multiplexing, OFDM, signal for use in data communication based on a data stream comprising complex input data symbols, said method comprising the steps of:
generating a time domain OFDM signal based on said complex input data symbols, wherein the generating comprises:
consecutively padding said N/2 subcarriers with N/2 zeros, thereby obtaining N subcarriers;
performing an N sized inverse Fourier Transform on said N subcarriers thereby providing N time domain signals at an output,
copying and flipping said time domain OFDM signal by means of a polarity inversion and appending said copied and flipped real-valued time domain OFDM signal to said time domain signal thereby obtaining a full time domain ACO-OFDM signal; and
clipping the full time domain ACO-OFDM signal to a positive valued signal.

14. A method for demodulating an asymmetrically Clipped Optical, ACO, Orthogonal Frequency Division Multiplexing, OFDM, signal for use in data communication based on a data stream comprising complex input data symbols, said method comprising the steps of:
un-flipping a second half of said ACO OFDM signal by means of polarity inversion and for merging said un-flipped second half of said ACO OFDM signal with a first half of said ACO OFDM signal, thereby obtaining a time domain ACO OFDM signal with reduced length; and
retrieving said complex input data symbols based on said obtained time domain OFDM signal with reduced length, said retrieving comprising:
performing an N sized Fourier Transform on said OFDM signal with reduced length, thereby obtaining N subcarriers; and
retrieving N/2 complex input data symbol from said obtained N subcarriers.

15. Computer program product comprising a non-transitory computer readable medium having instructions stored thereon which, when executed by a modulator or demodulator, cause said modulator or demodulator to implement a method in accordance with claim 13.

16. A time domain OFDM signal obtained by the method of claim 13.
